(19) United States
(12) Patent Application Publication
(10) Pub. No.: US 2009/0103306 A1
(43) Pub. Date: Apr. 23, 2009

(54) Light It Up

(76) Inventor: Michael Dean Hargraves, Angleton, TX (US)

Correspondence Address: Michael D. Hargraves, 509 South Downing, Angleton, TX, 77515, US

(21) Appl. No.: 11/773,553

(22) Filed: Oct. 17, 2007

(51) Int. Cl. F21V 7/20

(52) U.S. Cl. 362/294

(57) ABSTRACT

A recreational light system which can be used for any outdoor recreational activity. It consists of collapsible folding members which allows the unit to be easily stowed or transported. An extendable pole to allow for elevated positioning of lighting element(s). A ground fault circuit interrupter and system switch for easy controls and safety protection of lighting system. It includes a metallic reflector assembly to enhance lighting broadcast and heat dissipation. Reflector mounting allows for multi-angle positioning and has easily detachable mounting assembly to for transportation purposes.

### BACKGROUND OF THE INVENTION

1. Field of the Invention

The present invention is directed to improve recreational lighting with a high intensity light source mounted on a multi-functional stand for flexibility, stability, and with safety features. The support system is portable, adjustable and lightweight in design and is readily stowed or transported.

2. State of the Prior Art

For applications of this type, recreational users require high luminous sources to improve visibility. Prior lighting system use lower lumen lighting systems requiring either additional lighting requirement or remain insufficient in the amount of lighting required. In addition prior lighting systems lack adequate support or do not supply any support for high visibility.

Other designs do not accommodate the flexibility in stand movement. They do not incorporate a stable tripod support system out of light weight materials. Other designs do not have the capability to be easily stowed or transported. Other devices do not integrate the use of a Ground Fault Circuit Interrupter along with outlet control switches for safety and convenience.

### SUMMARY OF THE INVENTION

An object of the invention, therefore, is to provide a high lumens portable lighting system.

Another object of the invention is to provide a system that is readily assembled and disassembled.

Another object of the invention is to provide safe operating features to protect against unsafe conditions. This includes a Ground Fault Circuit Interrupter and radiant heat reflector.

Another object of the invention is to provide flexibility in light placement and positioning by providing hardware for easy and convenient placement.

### BRIEF DESCRIPTION OF THE DRAWINGS

The accompanying drawings, which are incorporated in and form a part of the specification, illustrate the preferred embodiments of the present invention, and together with the written description and claims, serve to explain the principles of the invention. In the drawings:

FIG. 1 is a front and side elevation view of a Light Assembly.

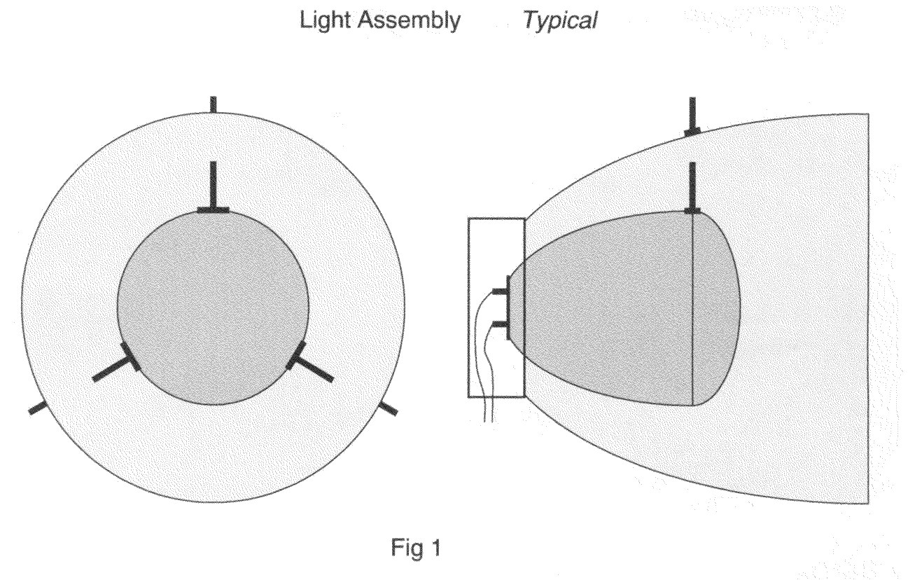

FIG. 2 is a front and side elevation view of a Single Light Assembly on a Portable Mounting System.

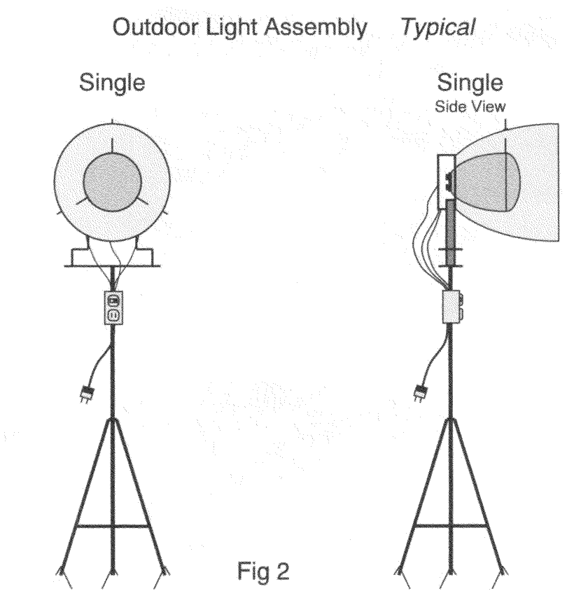

FIG. 3 is a front and side elevation view of a Double Light Assembly on a Portable Mounting System.

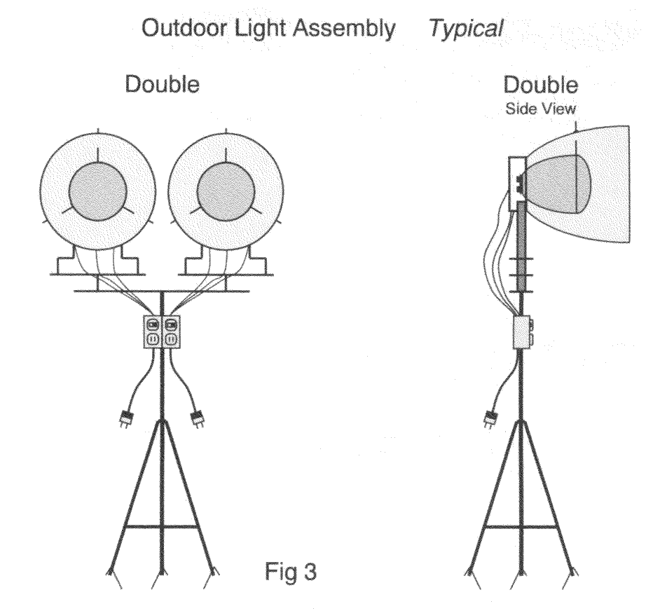

FIG. 4 is a front and side elevation view of a Light Assembly within a Box Mount System.

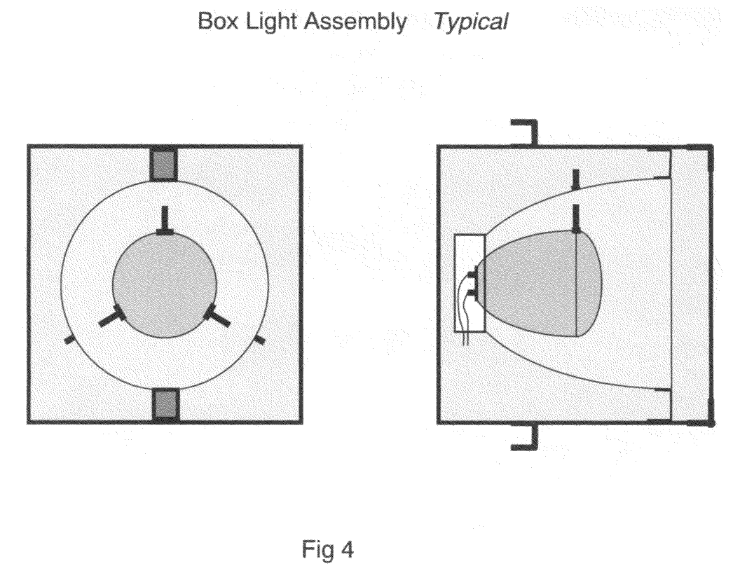

FIG. 5 is a electrical circuit diagram stating the wiring requirements for the light assembly.

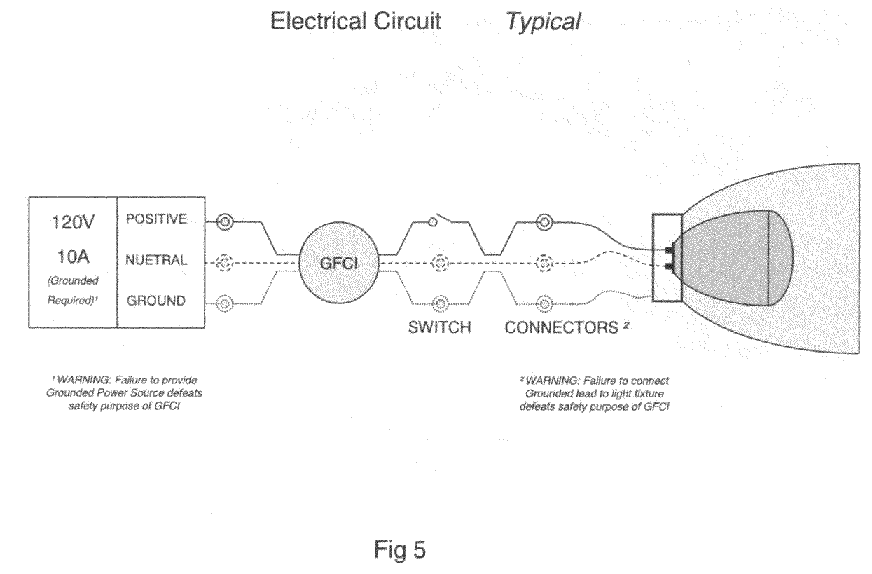

FIG. 6 is a Part Description Listing.

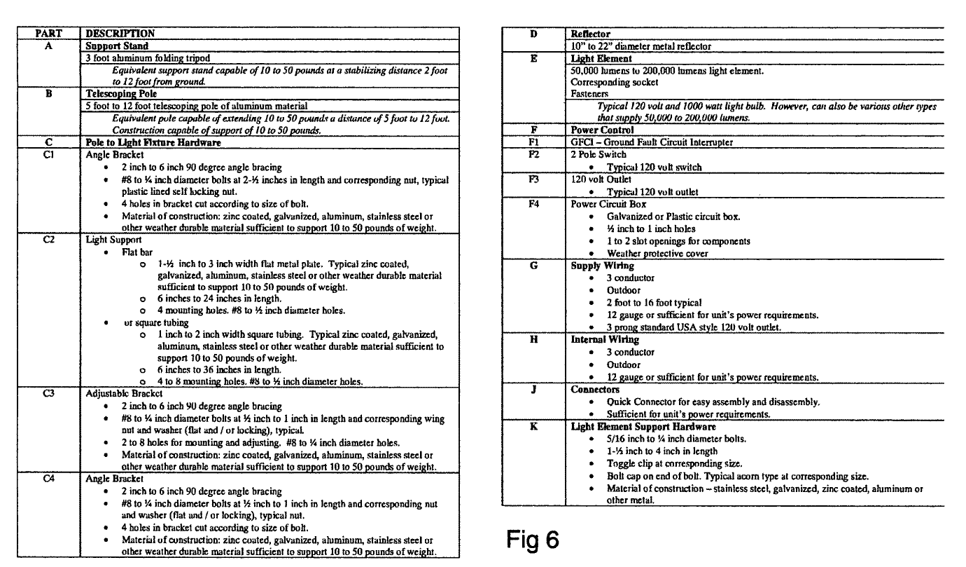

### SEQUENCE LISTING

The product is delivered in a dissembled condition.
1. Tripod assembly is first removed.
2. Tripod legs are separated into a triangular foot print pattern. This allows for the leg stand and stabilizes the upper members to be added.
3. Identify the telescoping pole and light mounting assembly. Insert this into the center of the tripod assembly. Fasten with mounting bolts as provided on the tripod assembly.
4. Adjust height of telescoping pole if desired. This can be accomplished by counter turning the compression band on the pole and extending a section for elevation.
5. Lighting element assembly can then be mounted to the receiving end of the mounting assembly on the telescoping pole. The unit is fastened by tightening the mounting bolts provided.
6. Power supply from the ground fault circuit interrupter control is connected by joining the power cables to the matching cables provided on the lighting element assembly. Match both the connector and the cable color.
7. Power is now supplied to the unit by connecting to the 3 prong 110V 15 amp male prong plug supplied from the ground fault circuit interrupter controls.
8. Unit is now fully assembled and ready to operate.
9. Power is supplied to the lighting element assembly by flipping the switch supplied on the ground fault circuit interrupter controls.
10. The ground fault circuit interrupter can be tested by pressing the “test” labeled button on the ground fault circuit interrupter controls.
11. The ground fault circuit interrupter can be reset by pressing the “reset” labeled button on the ground fault circuit interrupter controls.
12. Power can be turned off to the lighting element assembly by flipping the switch supplied on the ground fault circuit interrupter controls.
13. The unit can be dissembled by reversing the procedure for assembly and is then ready for stowing or transportation.

I claim:

1. A high lumens lighting assembly on a portable mounting system suitable for recreational activity in low lighting applications comprised of:
A. Lighting element assembly includes a high lumens light source and safety reflector featuring
1) Reflector dissipates heat radiation from light source
2) Reflector enhances light illumination
3) Reflector mounts on an assembly that enables multi-angle broadcast
4) Reflector mounts is easily disassembled for stowing or transportation
B. Power source for light element has protected controls featuring
1) Power circuit includes a ground fault circuit interrupter
2) Power circuit includes a control switch for each lighting element
3) Power circuit includes a single element 110V power source per each lighting element
C. The pole of the light stand is adjustable and lightweight featuring
1) Pole material used is light weight metal used such as aluminum.
2) Pole is adjustable height
3) Pole is collapsed and dissembled for stowing or transportation
D. Stand support device is a light weight tripod assembly featuring:
1) Tripod material used is light weight metal
2) Tripod will easily collapse when desired for disassembly for stowing or transportation
3) Tripod can be anchored to the ground by utilizing optional stakes
4) Tripod has two anchor points to adjustable height light assembly pole for stability
E. All exposed parts have corrosion protection featuring:
1) Some metallic parts utilize corrosion resisting materials such as stainless steel, aluminum or magnesium
2) Some parts are painted for additional corrosion resistance.
